(19) United States
(12) Patent Application Publication
(10) Pub. No.: US 2024/0330861 A1
(43) Pub. Date: Oct. 3, 2024

(54) ONE-WAY COLLABORATIVE CONTENT ITEM LOCKING SYSTEM

(71) Applicant: Dropbox, Inc., San Francisco, CA (US)

(72) Inventor: Assaf Dayan, Givatayim (IL)

(21) Appl. No.: 18/192,943

(22) Filed: Mar. 30, 2023

(51) Int. Cl. G06Q 10/10; G06F 21/62

(52) U.S. Cl. CPC G06Q 10/103; G06F 21/6209; G06F 2221/2141

(57) ABSTRACT

The present disclosure relates to systems, non-transitory computer-readable media, and methods for controlling editing permissions associated with individual user accounts for collaborative documents without affecting the editing permissions associated with additional user accounts using a straightforward and concise presentation. For instance, the disclosed systems provide uncomplicated options for presentation on a client device, which provide account-based control of the editing permissions associated with a user account for collaborative digital content items while maintaining the existing editing permissions associated with additional user accounts for the collaborative content items. In particular, the disclosed systems can identify a collaborative content item associated with a user account, determine editing permissions associated with the user account, provide an option to modify the editing permissions associated with the user account, and modify the editing permissions associated with the user account all without affecting the editing permissions associated with other accounts.

### BACKGROUND

Recent years have seen significant improvements in computer technology that have led to an extensive adoption of computer-based collaborative document editing tools by computer users. In particular, use of tools such as file sharing, project management systems, web and video conferencing tools, messaging tools, code hosting platforms, and other online collaboration platforms has become widespread. For example, many computer users interact with a multitude of computer-based document management and communication tools daily.

Despite these advances, however, existing systems often suffer from technological shortcomings that result in a number of deficiencies particularly in regard to efficient, flexible, and functional operation. For example, managing document editing tasks between users can be challenging, especially when there are multiple people working on the same document simultaneously. In particular, existing systems have difficulty controlling changes made by different users and providing sufficient safeguards to ensure that collaborative content items are not inadvertently modified. In part, because of this difficulty, existing systems utilize various inflexible permission control mechanisms to control who can view, edit, or delete a document.

Indeed, existing collaboration management systems often provide an inflexible level of control of collaborative content items and often provide only limited options with regard to managing access to collaborative content items. For example, existing systems often manage access for collaborative content items through permissions set by an owner user account or administrative user account based on categories such as user accounts and/or user groups. This system of access management can be useful for users working on a team project, but it also means that a user of a client device with editing permissions can inadvertently or purposefully make a damaging edit to alter or delete important content. Although existing systems provide a “read-only” mode that can be enabled for a document that prevents user accounts from making changes to the collaborative document, this setting can be overly restrictive and limiting when collaborating within a collaborative document. For example, existing systems do not sufficiently account for the situation in which a user of an existing system may need to view the collaborative document in some instances, yet the same user may need additional editing permissions in another instance. Thus, the existing systems require a controlling client device, or administrative user account, to swap between applications to update document permissions based on changing needs.

Similar to the above discussed disadvantages, existing systems also have additional functional weaknesses. For example, existing systems allow collaborative content items to be edited by multiple people at the same time, which can lead to conflicting changes or even content being overwritten, which makes it difficult to track changes and can result in important information being lost or modified. In particular, if two or more collaborators make conflicting changes to the collaborative content item, it can create confusion in existing systems concerning the intended changes by the collaborators and make it difficult to reconcile the changes. Indeed, in existing systems, reverting changes in a collaborative content item can be difficult, particularly if there have been multiple collaborators making changes to the collaborative content item. Additionally, if multiple contributors have made changes to the collaborative content item, it can be difficult to determine which changes should be reverted, particularly if the changes are conflicting. Furthermore, in some cases, changes to a collaborative content item may not be noticed until some time has passed, making it more difficult to revert the changes. Technical issues such as connectivity problems, software glitches, or power outages can lead to data loss or corruption, making it difficult to revert changes. Human error, such as accidentally saving the wrong version of a collaborative content item or failing to properly track changes, can also make it difficult to revert changes.

Existing collaborative content management systems also have inherent organizational inefficiencies. For example, when multiple user accounts modify a collaborative content item simultaneously, the system has an increased risk of errors due to conflicting changes. This can result in the need for user accounts to provide additional time and resources to resolve conflicts and ensure that the collaborative content item is accurate and error-free. When multiple user accounts are editing a collaborative content item simultaneously, the user accounts can have difficulty in maintaining consistency in terms of formatting, style, and tone, resulting in a collaborative content item that is disjointed and difficult to read.

Additionally, existing systems often inefficiently utilize computing resources. For example, existing systems often automatically send out notifications whenever a user account updates collaborative content items, even if the updates are subsequently reverted. Naturally, when a large number of user accounts perform a multitude of collaborative content item edits, this results in existing systems providing an excessive number of notifications to collaborators who have access to the collaborative content items. In turn, when sending a multitude of notifications, existing systems require additional system resources (e.g., additional memory, bandwidth, servers) to coordinate the deluge of digital information provided by changes to the collaborative content items. Unsurprisingly, the large number of collaborative content items that user devices may inadvertently update can result in an overwhelming number of user interactions to access, review, organize, and update, and locate content and can also bombard the client device with unnecessary notifications. These shortcomings can increase the burden on implementing devices resulting in longer interaction times and cause additional computational burdens for the implementing devices.

These, along with additional problems and issues, exist with regard to existing systems.

### BRIEF SUMMARY

One or more embodiments described herein provide benefits and/or solve one or more problems in the art with systems, methods, and non-transitory computer readable storage media to provide a system that controls editing permissions associated with individual user accounts for collaborative documents without affecting the editing permissions associated with additional user accounts using a straightforward and concise presentation. For instance, the disclosed systems provide intuitive options for presentation on a client device, which provide account-based control of the editing permissions associated with a user account for collaborative digital content items while maintaining the existing editing permissions associated with additional user accounts for the collaborative content items. In particular, the disclosed systems can identify a collaborative content item associated with a user account, determine editing permissions associated with the user account for the collaborative content item, provide an option to modify the editing permissions associated with the user account for the collaborative content item, and modify the editing permissions associated with the user account for the collaborative content item without affecting the editing permissions associated with other accounts for the collaborative content item. Accordingly, the systems described herein provide a one-way locking system that allows a user to lock editing permissions for their own user account while not affecting any permissions of other users that have access to the collaborative content item.

For example, the disclosed systems can provide a collaborative content item to a user account with a permission lock indication and, in response to a user interaction with the permission lock indication, disable the editing permissions associated with the user account for the collaborative content item. Indeed, the disclosed systems can modify temporary editing or persistent editing permissions for the collaborative content item associated with the user account without modifying the editing permissions for the collaborative content item associated with other user accounts. Furthermore, the disclosed system can modify global editing permissions for multiple collaborative content items associated with the user account without modifying the editing permissions for the collaborative content items associated with other user accounts. In addition, the disclosed system can modify partial editing permissions for multiple collaborative content items associated with the user account without modifying the editing permissions for the collaborative content items associated with other user accounts. Accordingly, based on limited user interaction with a graphical user interface, the disclosed systems can provide an intuitive, flexible, and efficient way to manage permissions for specific user accounts for associated collaborative content items.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment within which a collaborative document locking system can operate in accordance with one or more embodiments;

FIG. 2 illustrates an example of a collaborative document locking system in accordance with one or more embodiments;

FIG. 3 illustrates a sequence diagram illustrating modifying user account permissions for collaborative content items in accordance with one or more embodiments;

FIGS. 4A-4B illustrate an example collaborative document locking system graphical user interface in accordance with one or more embodiments;

FIG. 5 illustrates an example collaborative document locking system permission data table which includes lock/unlock permissions assigned to user accounts for various collaborative content items;

FIG. 6 illustrates a flowchart of a series of acts for modifying user account permissions for a collaborative content item in accordance with one or more embodiments;

FIG. 7 illustrates a block diagram of an exemplary computing device in accordance with one or more embodiments; and

FIG. 8 illustrates a networking environment of a collaborative document locking system in accordance with one or more embodiments.

### DETAILED DESCRIPTION

This disclosure describes embodiments of a collaborative document locking system that coordinates local editing permissions associated with individual user accounts for collaborative content items without affecting the editing permissions associated with other user accounts using an intuitive and concise presentation. In particular, the collaborative document locking system provides one or more options to allow a user account to lock or limit editing permissions for the user account itself, while not affecting editing permissions for other user accounts. For instance, the collaborative document locking system provides straightforward options for presentation on a client device which provide account-based control of the editing permissions associated with a user account for collaborative digital content items while maintaining the existing editing permissions associated with additional user accounts for the collaborative content items. In particular, the collaborative document locking system can identify a collaborative content item associated with a user account, determine editing permissions associated with the user account for the collaborative content item, provide options to modify the editing permissions associated with the user account for the collaborative content item, and modify the editing permissions associated with the user account for the collaborative content item without affecting the editing permissions associated with other accounts for the collaborative content item.

Indeed, in one or more embodiments, the collaborative document locking system provides a collaborative content item for display within a graphical user interface along with a lock indication toggle that indicates the editing permissions associated with the user account for the collaborative content item. As another example, the collaborative document locking system can provide, via the client device, a visible indication of the locked status or unlocked status of the collaborative content item. Furthermore, the collaborative document locking system receives user input indicating a selection of the lock indication that indicates a desired change to the editing permissions associated with the user account for the collaborative content item. As noted, the collaborative document locking system modifies the editing permissions associated with the user account itself while maintaining the editing permissions associated with additional user accounts for the collaborative content item.

Further, in one or more implementations, the collaborative document locking system receives user input indicating a selection of a desired change to the editing permissions associated with the user account for the collaborative content item. Indeed, as part of modifying the editing permissions associated with the user account, the collaborative document locking system can change permissions for a variety of content items, and for a variety of durations, and for a variety of feature types. As noted, the collaborative document locking system changes these editing permissions associated with the user account for the collaborative content item while maintaining the editing permissions associated with additional user accounts for the collaborative content item.

For example, the collaborative document locking system can modify (e.g., enable and/or disable) editing permissions for the current collaborative content item, selections within the collaborative content item, or multiple collaborative content items. For example, the collaborative document locking system can modify editing permissions globally (e.g., for all collaborative content item associated with the user account), specifically (e.g., for a specific collaborative content item), based on a selection (e.g., a selection within the collaborative content item), based on a user account (e.g., collaborative content items associated with specific user accounts), based on a user group, based on a project, and/or based on a time stamp (e.g., collaborative content items associated with a specific time/date range).

In addition, the collaborative document locking system can modify editing permissions for different durations. As an example, the collaborative document locking system can modify the editing permissions for a set time period, a persistent time period (e.g., until disabled), or upon opening the document (e.g., for a set time period after opening). Indeed, in one or more implementations, the collaborative document locking system changes the locked status (e.g., lock the editing permissions or unlock the editing permissions) of the collaborative content item until the collaborative document locking system receives an indication to revert the locked status (e.g., unlock the editing permissions or lock the editing permissions). In one or more implementations, the collaborative document locking system maintains the locked status for the editing permissions of the collaborative content item until the end of a viewing session by the user account.

As mentioned, the collaborative document locking system can modify editing permissions associated with a variety of features. For example, the collaborative document locking system can modify editing permissions including permissions associated with modifying content, adding content, removing content, formatting content, executing content, emphasizing content, and/or adding comments. Furthermore, in one or more embodiments, the collaborative document locking system can update a permission data table associated with the collaborative content item. In particular, the collaborative document locking system can utilize a permission data table to manage permissions for user accounts. For example, the collaborative document locking system can utilize a permission data table to indicate which permissions are granted to each user account for each collaborative content item.

The collaborative document locking system provides many technological advantages and benefits over existing systems and methods. For example, the system improves efficiency, flexibility, and functionality relative to existing systems. Specifically, in one or more embodiments, the collaborative document locking system improves efficiency by alleviating the increased risk of errors due to conflicting changes to the collaborative content item from multiple user accounts. For example, a user account without the need to edit a collaborative content item (but with the need to access the collaborative content item) can lock editing for the user account for the collaborative content item for a specified time and/or feature and eliminate the chance for an unintended change to the collaborative content item. Indeed, the collaborative document locking system can minimize inconsistencies caused by inadvertent conflicting changes to content, formatting, and/or comments in the collaborative content item. Undeniably, the collaborative document locking system can minimize the burden on system resources that is created when users of user accounts must discover, correct, revert, and compensate for inadvertent changes through additional access, modifications, and synchronizations to collaborative content items.

Similarly, the collaborative document locking system improves efficiency by conserving system resources in other ways. For example, the collaborative document locking system can minimize system generated notifications that are sent out whenever user accounts update collaborative content items. By minimizing the inadvertent changes through disabling editing permissions for user accounts, the collaborative document locking system saves system resources in terms of minimizing the memory, bandwidth, and computer systems needed to accommodate the deluge of digital information provided by sending update notifications regarding inadvertent changes to a multitude of collaborative content items.

Further, the collaborative document locking system provides more flexibility relative to existing systems. For instance, the collaborative document locking system provides an innovative permission locking model to coordinate user account editing permissions associated with individual user accounts for collaborative content items without affecting the editing permissions associated with other user accounts for the collaborative content items. Indeed, the collaborative document locking system can receive user account input indicating a selection of the lock indication (or through other user input selection) and a desired change to the editing permissions associated with the user account for the collaborative content item that only affects the permissions associated with the user account. Indeed, the user account can modify user account permissions without the need to modify the permissions associated with other user accounts for the collaborative content item. Further, the collaborative document locking system can receive user input indicating a selection of a requested modification to permissions based on a variety of convenient categories including the lock target (e.g., associated files), lock duration (e.g., associated time-period), and feature locks (e.g., associated features).

Similarly, in one or more implementations, the collaborative document locking system provides a functional improvement in the way the computer operates by providing configurable permission control for collaborative content items associated with individual user accounts. Specifically, the collaborative document locking system introduces an improvement to the basic function of a computing task management system by providing configurable permission control and alleviating the hazard of inadvertent changes to collaborative content items and the ensuing confusion concerning the actual intended (or unintended) changes by the collaborators. For example, if two or more collaborators access a collaborative content item, the collaborative document locking system can alleviate confusion concerning intended changes by the collaborators by providing a method for the collaborator associated with a user account to disable unnecessary permissions for the user account. Indeed, the collaborative document locking system can alleviate the occurrence of changes to a document that remain unnoticed until some time has passed, where those changes can be more difficult and/or time consuming for the user account to track down and revert. In addition, by disabling permissions, the collaborative document locking system can alleviate the concern over technical issues such as connectivity problems, software glitches, or power outages that can lead to data loss or corruption, making it difficult to revert changes.

Indeed, the collaborative document locking system can provide a simplified interface to enable the user account to straightforwardly enable or disable editing permissions to the collaborative content item. For example, existing systems often require a user to navigate through multiple GUIs and user interfaces to be able to set permissions for the collaborative content item. In contrast, the system described herein provides, in some embodiments, a customized user account permission control with a single interaction thereby significantly reducing the number of interaction steps needed to set individual user account editing permissions for the collaborative content item when compared to existing systems. Furthermore, the system described herein provides, in some embodiments, an intuitive menu system that simplifies the process for the user account to set a wide-ranging variety of user account editing permissions for the collaborative content item (e.g., duration, associated user accounts, associated time/date, editing features) instead of requiring user account interaction with multiple GUIs and user settings as is necessary when utilizing existing systems.

As illustrated by the foregoing discussion, the present disclosure utilizes a variety of terms to describe features and benefits of the collaborative document locking system. Additional detail is now provided regarding the meaning of these terms. In particular, as used herein the term “collaborative content item” refers to any piece of digital content that is accessible simultaneously by multiple user accounts. A collaborative content item can include collaborative written documents, audio or video recordings, or other forms of digital media. For example, collaborative content items can be accessed using a variety of tools and platforms, such as shared online document editors, project management software, or communication tools that allow user accounts to coordinate in real-time or asynchronously. DROPBOX PAPER is an example of a collaborative content item that allows multiple users to work on the same document simultaneously, providing a seamless collaborative experience.

Similarly, as used herein the term “content management system” refers to a software application system that can be used to create, facilitate, access, and/or manage collaborative content items. In particular, a content management system can provide a centralized platform for managing and organizing content, while also facilitating communication and collaboration among user accounts. For example, DROPBOX is project management software that provides real-time editing, commenting, version control, and task assignment to make it easier for user accounts to communicate and collaborate effectively when utilizing collaborative content items.

As used herein, the term “editing permissions” refers to the level of access that a user account has been provided to edit, modify, or contribute to a collaborative content item in a collaborative environment. In particular, editing permissions can refer to permissions associated with the collaborative content item based on the user account or the user account group. For example, the editing permissions can include editing permissions for a user account associated with a lock target, a lock duration, and/or a feature lock. The collaborative document locking system utilizes editing permissions to help prevent accidental or unauthorized changes to the content, while also enabling efficient collaboration and workflow management.

Further, as used herein, “locked status” (or “locked”) refers to a restriction on the ability of user accounts to modify or edit a particular collaborative content item. When the locked status is enabled, the user account associated with the collaborative content item cannot make certain changes to the collaborative content item. For example, the collaborative document locking system creates a locked status by locking (e.g., removing) editing permissions associated with the lock target, lock duration, or content features. Relatedly, as used herein, the “unlocked status” (or “unlocked”) refers to a state in which a collaborative content item can be freely edited or modified by user accounts with appropriate access permissions. When a collaborative content item is in an unlocked status, changes can be made without restriction. Additionally, as used herein, the term “lock indication” refers to a signal or indicator to enable the locked status or unlocked status of a collaborative content item.

Moreover, as used herein, “global editing permissions” refers to the level of access that a user account has been provided across an entire system or organization. In particular, global editing permissions can refer to permissions to access multiple documents, folders, projects, or collaborative content items, rather than just access to a single collaborative content item. For example, modifying global editing permissions refers to modifying the editing permissions for all collaborative content items associated with a specific user account. Relatedly, as used herein, “global locked status” (or “global lock”) refers to a restriction on the ability of a user account to modify or edit multiple collaborative content items within a system. In particular, when the global locked status is enabled, the user account associated with collaborative content items within a system cannot make certain changes (e.g., disabled features) to all collaborative content items associated with a specific user account. Relatedly, as used herein, the term “global lock indication” refers to a signal or indicator to enable the globally locked status regarding collaborative content items.

Further, as used herein, the term “partial-locked status” (or “partial-lock”) refers to a partial restriction on the ability of user accounts to access or edit a particular collaborative content item. In particular, when the collaborative document locking system employs a partial-locked status, some (but not all) access to a collaborative content item is locked or unavailable. For example, in a collaborative environment, a user account may lock a particular section of the collaborative content item to avoid accidentally making conflicting or duplicative changes to the section of the collaborative content item. When the user account is ready to make changes, the user account can release the lock, allowing the user account to make changes to that section. Furthermore, as used herein, the term “partial-lock indication” refers to a signal or indicator to enable the partial-locked status regarding a collaborative content item.

Relatedly, as used herein, the term “time-based locked status” (or “time-based lock”) refers to a status where access to a collaborative content item is temporarily restricted for a specific period of time. For example, a time-based locked status may be used by a user account to restrict access to certain collaborative content items for a specific length of time or during specific times of the day. Furthermore, as used herein, the term “time-based lock indication” refers to a signal or indicator to enable the time-based locked status regarding a collaborative content item.

In addition, as used herein, “user-specific locked status” (or “user-specific lock”) refers to a restriction on the ability of a user account to modify or edit collaborative content items associated with another user account. In particular, when the user-specific locked status is enabled, the user account associated with collaborative content items within a system cannot make certain changes to the collaborative content items associated with another user account. Relatedly, as used herein, the term “user-specific lock indication” refers to a signal or indicator to enable the user-specific locked status regarding a collaborative content item.

Relatedly, as used herein, the term “group-specific indication” refers to a restriction on the ability of a user account to modify or edit collaborative content items associated with a group of user accounts. In particular, when the group-specific locked status is enabled, the user account associated with collaborative content items within a system cannot make certain changes to the collaborative content items associated with a group of user accounts. Relatedly, as used herein, the term “group-specific lock indication” refers to a signal or indicator to enable the user-specific locked status regarding a collaborative content item.

As used herein, the term “viewing session” refers to a period of time during which a user account interacts with a collaborative content item. In particular, a viewing session can involve the period of time a user account accesses a collaborative content item on a computer or mobile device. For example, the time from when a user account opens a collaborative content item until the time when a user account closes a collaborative content item is a viewing session.

Moreover, as used herein, the term “permission data table” refers to a data structure used by a content management system to manage and enforce user permissions or access collaborative content items. In particular, the permission data table can consist of a table or matrix that lists different types of permissions or access rights that can be allocated to user accounts, as well as additional user accounts associated with the permissions. For example, the cells of the permission data table can indicate whether a particular user account has permission to access the collaborative content item or perform an action associated with the collaborative content item.

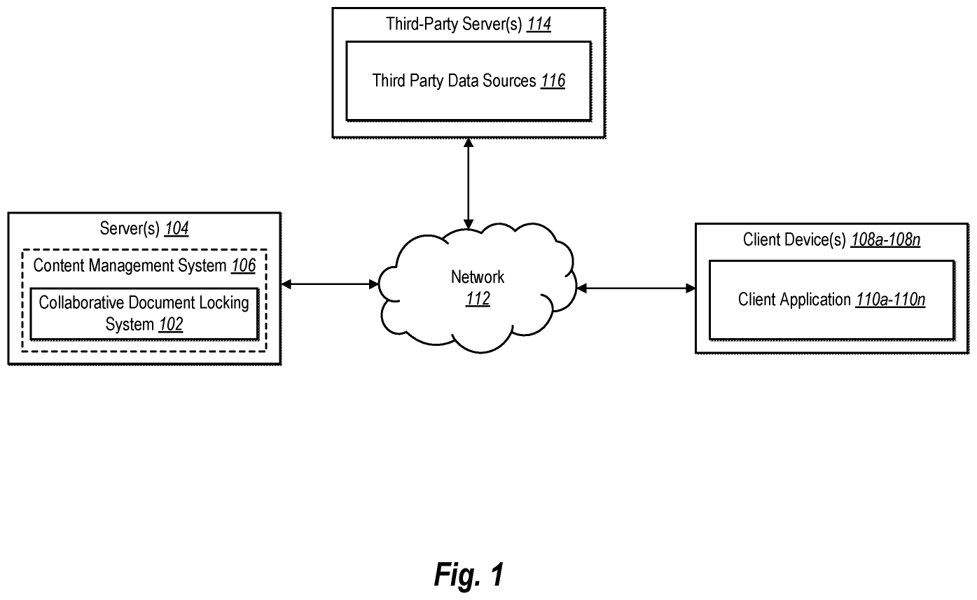

Additional detail regarding the collaborative document locking system will now be provided with reference to the figures. For example, FIG. 1 illustrates a schematic diagram of an exemplary system environment (“environment”) 100 in which a collaborative document locking system 102 can be implemented. An overview of the collaborative document locking system 102 is described in relation to FIG. 1. Thereafter, a more detailed description of the components and the processes of the collaborative document locking system 102 is provided in relation to the subsequent figures.

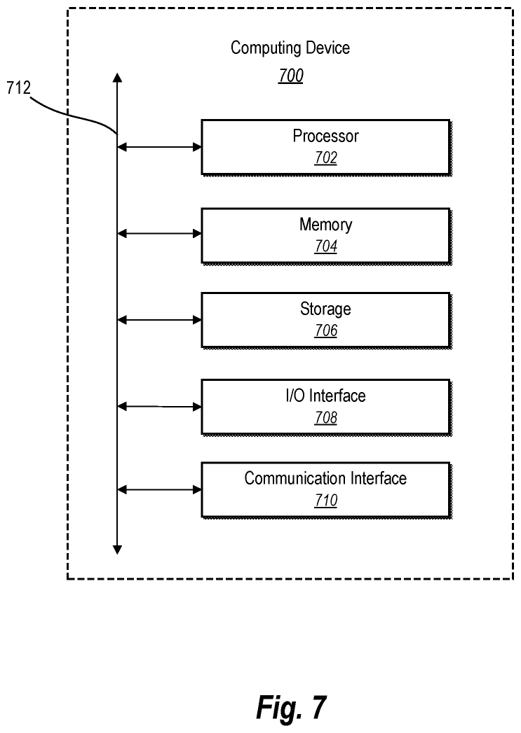

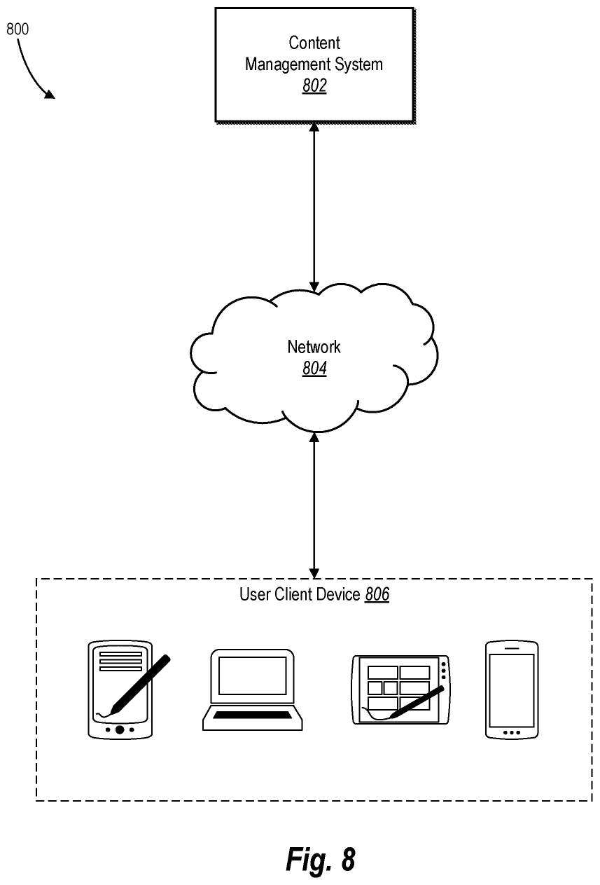

As shown, the environment includes server(s) 104 and client device(s) 108a-108n. The client device(s) 108a-108n can be one of a variety of computing devices, including a smartphone, a tablet, a smart television, a desktop computer, a laptop computer, a virtual reality device, an augmented reality device, or another computing device as described in relation to FIGS. 7-8. The client device(s) 108a-108n can communicate with the server(s) 104 and or third-party server(s) 114 via the network 112. For example, the client device(s) 108a-108n can receive user input from respective users interacting with the client device(s) 108a-108n (e.g., via the content management system 106) to, for instance, access, generate, modify, add, delete, share or to lock/unlock collaborative content items (e.g., via the collaborative document locking system 102). In addition, the collaborative document locking system 102 on the server(s) 104 can receive information relating to various interactions with content and/or user interface elements based on the input received by the client device(s) 108a-108n (e.g., to lock/unlock access to content).

As shown, the client device(s) 108a-108n can include a content management system 106. In particular, the content management system 106 may be a native application installed on the client device(s) 108a-108n (e.g., a mobile application, a desktop application, etc.), or a cloud-based or web application where all or part of the functionality is performed by the server(s) 104. Based on instructions from the content management system 106, the client device(s) 108a-108n can present or display information, including user interfaces that includes depictions of collaborative content items.

As illustrated in FIG. 1, the example environment also includes the server(s) 104. The server(s) 104 may generate, track, store, process, receive, and transmit electronic data, such as digital collaborative content items, interactions with digital collaborative content items, and/or interactions between user accounts or client devices. For example, the server(s) 104 may receive data from the client device(s) 108a-108n in the form of a request to generate a collaborative content item, interact with a collaborative content item, or lock/unlock a collaborative content item on the client device(s) 108a-108n. Indeed, the server(s) 104 can communicate with the client device(s) 108a-108n to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning servers, and other types of servers.

As shown in FIG. 1, the server(s) 104 can also include the collaborative document locking system 102 as part of a content management system 106. The content management system 106 can communicate with the client device(s) 108a-108n to perform various functions associated with the content management system 106 such as managing user accounts, managing content collection, managing collaborative content items, managing collaborative tasks, and facilitating user interaction with the collaborative content items. The content management system 106 can communicate with the third-party server(s) 114 to perform various functions associated with the collaborative document locking system 102 such as identifying and collecting third-party data for the synthesized tasks. Indeed, the content management system 106 can include a network-based cloud storage system to manage, store, and maintain content items and related data across numerous user accounts.

As shown in FIG. 1, the third-party server(s) 114 can include third-party data sources 116. In some embodiments, the collaborative document locking system 102 and/or the content management system 106 access the third-party server(s) 114 to access and obtain information from third-party data sources 116 such as digital collaborative content items, collaborative content attributes, and other information. In some embodiments, the collaborative document locking system 102 and/or the content management system 106 access the client device(s) 108a-108n to access and obtain information from third-party data sources 116 such as digital collaborative content items, collaborative content attributes, and other information.

Although FIG. 1 depicts the collaborative document locking system 102 located on the server(s) 104, in some implementations, the collaborative document locking system 102 may be implemented by one or more components of the environment (e.g., located entirely or in part). For example, the collaborative document locking system 102 may be implemented by the client device(s) 108a-108n, and/or a third-party device. For example, the client device(s) 108a-108n can download all or part of the collaborative document locking system 102 for implementation independent of, or together with, the server(s) 104.

In some implementations, though not illustrated in FIG. 1, the environment may have a different arrangement of components and/or may have a different number or set of components altogether. For example, the client device(s) 108a-108n may communicate directly with the collaborative document locking system 102, bypassing the network 112. As another example, the environment may include multiple client devices, each associated with a different user account for managing digital collaborative content items.

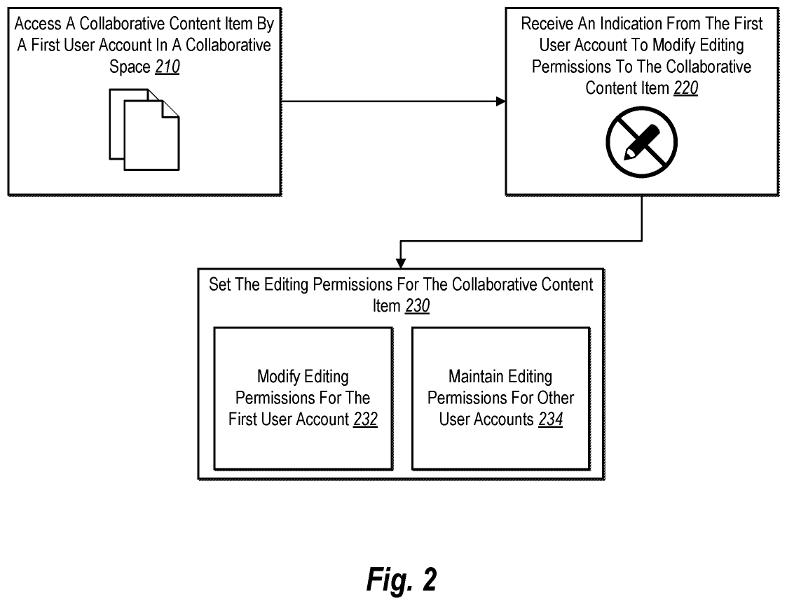

As mentioned above, the collaborative document locking system 102 can flexibly modify editing permissions (e.g., lock/unlock) for a user account while maintaining editing permissions for other user accounts. FIG. 2 illustrates an overview of accessing collaborative content item, receiving an indication to modify editing permissions of the collaborative content item, and setting the editing permissions for the collaborative content item in accordance with one or more embodiments. Additional detail regarding the various acts of FIG. 2 is provided thereafter with reference to subsequent figures.

As illustrated in FIG. 2, the collaborative document locking system 102 performs an act 210 to access a collaborative content item by a first user account in a collaborative space. For example, the collaborative document locking system 102 accesses content items that can include digital images, digital documents, social networking data, calendar data, webpages, digital messages, phone application data, and/or collaborative content items of other types. In some embodiments, the collaborative document locking system 102 accesses content that includes digital collaborative content stored in one or more network locations associated with the content management system 106 (and tied to a user account).

As further illustrated in FIG. 2, the collaborative document locking system 102 performs an act 220 to receive an indication from the first user account to modify editing permissions associated with the first user account, including an indication to enable or disable editing permissions, for the collaborative content item. In particular, the collaborative document locking system 102 receives an indication from the first user account to modify one or more editing permissions including a lock target, a lock duration, or a feature lock associated with a first user account for the collaborative content item without modifying the editing permissions associated with other user accounts for the collaborative content item. For example, the collaborative document locking system 102 can receive an indication from the client device associated with the first user account to lock a collaborative content item from being edited by the first user account for the duration of the viewing session.

Furthermore, the collaborative document locking system 102 can perform the act 230 to set the editing permissions associated with the first user account for the collaborative content item while maintaining editing permissions for other user accounts. In particular, the collaborative document locking system 102 can perform the act 232 to modify the editing permissions for the first user account based on the indication received in act 220. For example, the collaborative document locking system 102 can modify the editing permissions to disable various editing permissions associated with the first user account for the collaborative content item as requested by the first user account and thereby restrict the access of the first user account when interacting with the collaborative content item.

Additionally, as shown, the collaborative document locking system 102 can perform act 234 to maintain the editing permissions for other user accounts. Indeed, when the collaborative document locking system 102 performs act 232 to modify the editing permissions associated with the first user account, the collaborative document locking system 102 does not alter the editing permissions associated with other user accounts. For example, the collaborative document locking system 102 can disable the editing permissions associated with the first user account for the collaborative content item yet maintain the editing permissions for the collaborative content item associated with all other user accounts. Indeed, in one or more embodiments, the collaborative document locking system 102 can transparently maintain the editing permission for the other user accounts without notifying the other user account that the collaborative document locking system 102 has locked the editing permissions for the first user account. Additionally, in one or more embodiments, the collaborative document locking system 102 can maintain the editing permission for the other user accounts while providing a notification to other user accounts that the collaborative document locking system 102 has locked the editing permissions for the first user account.

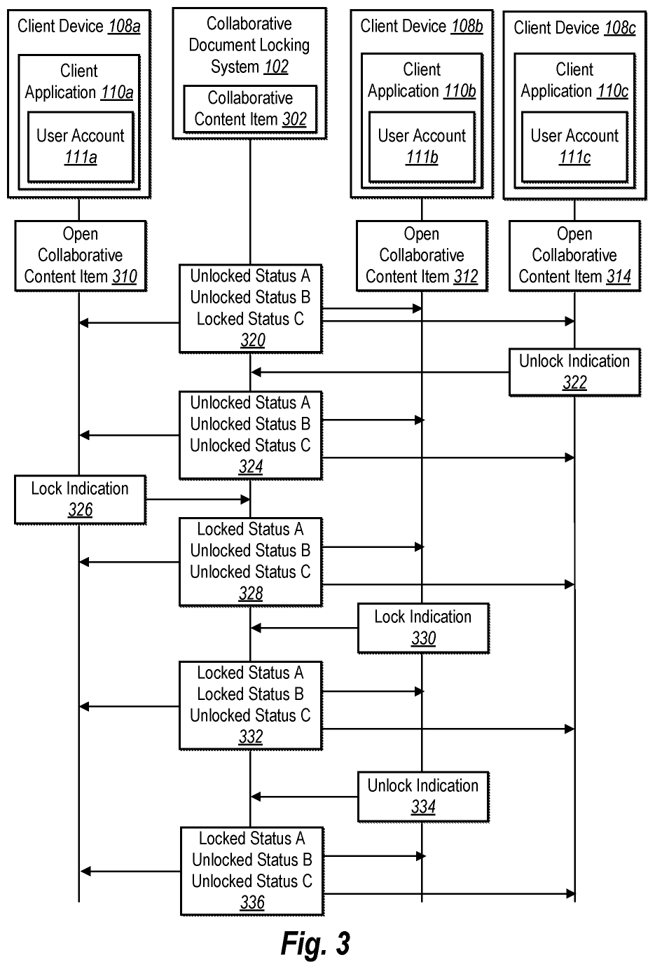

As mentioned above, in one or more embodiments, the collaborative document locking system 102 coordinates modifying editing permissions associated with user accounts for collaborative content items (e.g., utilizing client applications 110a-110n on client devices 108a-108n). In particular, the collaborative document locking system 102 disables and/or enables the permissions associated with individual user accounts for collaborative content items independent of the permissions associated with other user accounts. FIG. 3 illustrates an interaction between individual user accounts and the collaborative document locking system 102 to modify individual user account permissions for a collaborative content item according to one or more embodiments.

As illustrated in FIG. 3, the user accounts 111a, 111b, and 111c can collaboratively access the collaborative content item 302 and request independent modifications to the editing permissions associated with the requesting user accounts (e.g., user account 111a requests changes to the editing permissions associated with user account 111a) without affecting the editing permissions of the other user accounts (e.g., the other user accounts 111b and 111c). As shown, the client device 108a runs the client application 110a and performs the act 310 to open (or access) a collaborative content item 302 for user account 111a. As further shown, the client device 108b runs the client application 110b and performs the act 312 to open (or access) the collaborative content item 302 for user account 111b. As further shown, the client device 108c runs the client application 110c and performs the act 314 to open (or access) the same collaborative content item 302 for user account 111c.

The collaborative document locking system 102 performs act 320 to provide a locked or an unlocked status associated with the client applications 110a, 110b, and 110c respectively associated with the user accounts 111a, 111b, and 111c for the collaborative content item wherein the locked/unlocked status corresponds to the locked/unlocked status for the individual user accounts. In particular, the locked or unlocked status A corresponds to the editing permissions for user account 111a, the locked or unlocked status B corresponds to the editing permissions for user account 111b, and the locked or unlocked status C corresponds to the editing permissions for user account 111c. As shown on FIG. 3, when the user accounts 111a, 111b, and 111c open the collaborative content item 302, the collaborative document locking system 102 assigns user account 111a an unlocked status A, the user account 111b an unlocked status B, and the user account 111c a locked status C.

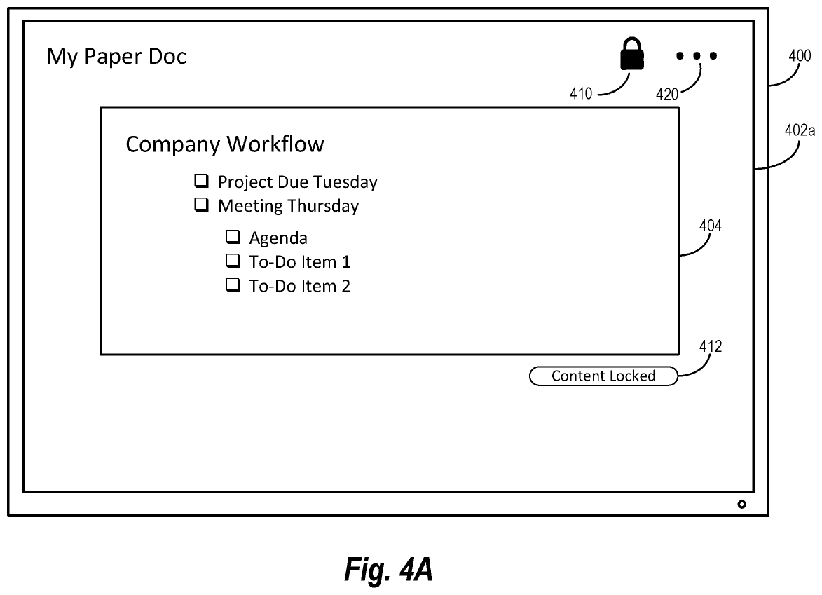

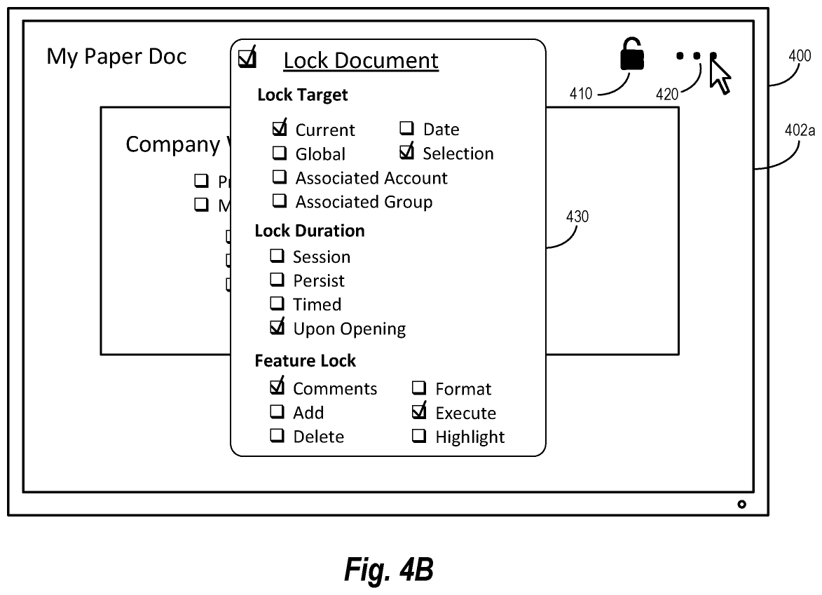

In particular, as shown in FIG. 3, user accounts 111a and 111b are opened with an unlocked status (e.g., unlocked status A and unlocked status B) and the collaborative document locking system 102 provides unrestricted editing permissions associated with the user accounts 111a and 111b for the collaborative content item 302. In contrast, user account 111c is opened with a locked status (e.g., locked status C) and the collaborative document locking system 102 provides restricted editing permissions associated with the user account 111c for the collaborative content item 302. For example, the collaborative document locking system 102 can lock (e.g., restrict) the editing permissions associated with the user account 111c without restricting the editing permissions associated with the user accounts 111a and 111b. Indeed, the collaborative document locking system 102 can lock the editing permissions for the user account 111c in a variety of ways including based on the lock target, the lock duration, and a feature lock as discussed in more detail below in relation to FIGS. 4A-4B.

As further shown, the user account 111c provides an unlock indication 322 to the collaborative document locking system 102 via the client application 110c. Based on receiving the unlock indication 322, the collaborative document locking system 102 performs act 324 to enable the editing permissions associated with the user account 111c for the collaborative content item 302 to create an unlocked status C. Indeed, as mentioned, the collaborative document locking system 102 can provide unrestricted editing permissions to the collaborative content item 302 for user account 111c corresponding to the unlocked status C. Notably, in the act 324, the collaborative document locking system 102 maintains the unlocked status A associated with user account 111a and unlocked status B associated with user account 111b.

Furthermore, the user account 111a provides a lock indication 326 to the collaborative document locking system 102 via the client application 110a. Based on receiving the lock indication 326, the collaborative document locking system 102 performs act 328 to disable the editing permissions associated with the user account 111a for the collaborative content item 302 to create a locked status A. Indeed, as mentioned, the collaborative document locking system 102 can lock the editing permissions for user account 111a in a variety of ways including based on the lock target, the lock duration, and a feature lock as discussed in more detail below in relation to FIGS. 4A-4B. Notably, in act 328, the collaborative document locking system 102 maintains the unlocked status B associated with user account 111b and unlocked status C associated with user account 111c.

Additionally, the user account 111b provides a lock indication 330 to the collaborative document locking system 102 via the client application 110b. Based on receiving the lock indication 330, the collaborative document locking system 102 performs act 332 to disable the editing permissions associated with the user account 111b for the collaborative content item 302 and create a locked status B. Indeed, as mentioned, the collaborative document locking system 102 can lock the editing permissions for user account 111b in a variety of ways including based on the lock target, the lock duration, and a feature lock as discussed in more detail below in relation to FIGS. 4A-4B. Notably, in act 332, the collaborative document locking system 102 maintains the locked status B associated with user account 111b and unlocked status C associated with user account 111c.

As further shown, the user account 111b provides an unlock indication 334 to the collaborative document locking system 102 via the client application 110b. Based on receiving the unlock indication 334, the collaborative document locking system 102 performs act 336 to enable the editing permissions associated with the user account 111b for the collaborative content item 302 to create an unlocked status B. Indeed, as mentioned, the collaborative document locking system 102 can provide unrestricted editing permissions to the collaborative content item 302 for user account 111b corresponding to the unlocked status B. Notably, the collaborative document locking system 102 maintains the locked status A associated with user account 111a and unlocked status C associated with user account 111c.

As shown in FIG. 3, the collaborative document locking system 102 can disable and enable editing permissions associated with a first, second, and third user account (and similarly to unlimited number of additional user accounts) by creating a locked status or an unlocked status for the associated user account while maintaining the editing permissions associated with the additional user accounts for the collaborative content item. Indeed, as mentioned, the collaborative document locking system 102 can lock the editing permissions for each user account in a variety of ways including based on the lock target, the lock duration, and a feature lock based on a request received from the user account as discussed in more detail below.

As mentioned, the collaborative document locking system 102 provides a collaborative content item for display on a client device (e.g., the client devices 108a-108n) within a collaborative space. In particular, FIGS. 4A-4B illustrate the collaborative document locking system 102 collaborative space interface 402a displayed via a computing device 400 in accordance with one or more embodiments.

As shown on FIG. 4A, the collaborative document locking system 102 displays the graphical representation of the collaborative content item 404 within the collaborative space interface 402a along with a selectable option 410 and/or a selectable menu option 420. In particular, the collaborative document locking system 102 can display a selectable option 410 on the user device that the user can interact with (e.g., select) to toggle between enabling or disabling editing permissions for the collaborative content item 404. In addition, the collaborative document locking system 102 can provide a locked status indication (or unlocked status indication) that the collaborative content item is locked through changing the appearance of the selectable option 410 from a closed lock icon (e.g., locked status) to an open lock icon (e.g., unlocked status). Furthermore, the collaborative document locking system 102 can provide other signals indicators for the locked status indication (or unlocked status indication) that shows a collaborative content item is locked/restricted (or unlocked/unrestricted) such as the visual indication 412. Furthermore, locked status indications may also include audible signals, such as alarms or beeps, to provide additional feedback to the user account on the locked status. In addition, the collaborative document locking system 102 can provide a partial-locked status indication to indicate that a user account has a partial-locked status regarding a collaborative content item.

As further shown in FIG. 4B, the collaborative document locking system 102 can provide and utilize a selectable menu 430 (e.g., accessed by the selectable menu option 420) within the collaborative space interface 402a. As mentioned, the collaborative document locking system 102 can provide various locked and unlocked statuses to provide the user accounts with flexible account-based control of the collaborative content item. In particular, as shown, the collaborative document locking system 102 can lock a collaborative content item for the user account based on a lock target, lock duration, and/or feature lock. Notably, as shown, the collaborative document locking system 102 can lock/unlock the collaborative content item based on one or more selectable options concurrently.

As mentioned, the collaborative document locking system 102 can lock/unlock a collaborative content item based on the lock target. In particular, the collaborative document locking system 102 can lock the collaborative content item based on a current collaborative content item, global collaborative content items, accounts associated with the collaborative content item, groups associated with the collaborative content item, dates associated with the collaborative content item, or a selected content within the collaborative content item.

As an example, the collaborative document locking system 102 can lock/unlock the editing permissions of the current collaborative content item to create a locked status or an unlocked status for the user account with regards to the collaborative content item. Indeed, in one or more embodiments, based on a user interaction with the current selection option (e.g., lock indication), the collaborative document locking system 102 can modify the editing permissions associated with the user account for accessing the current collaborative content item. In one or more implementations, the collaborative document locking system 102 can be a comprehensive lock that disables all editing permissions associated with the first user account for the collaborative content item. Notably, in one or more implementations, the locked/unlocked editing permissions are not a comprehensive limitation that restricts all editing permissions associated with the user account for the collaborative content item, nor are they limited to only one collaborative content item and can be classified as further as described below.

For example, the collaborative document locking system 102 can lock/unlock the editing permissions of a global set of collaborative content items to create a locked status or an unlocked status for the user account with regards to the global set of collaborative content items. Indeed, in one or more embodiments, based on a user interaction with the global selection option (e.g., global lock indication), the collaborative document locking system 102 can modify the editing permissions associated with the user account accessing the collaborative content item for all of the collaborative content items associated with the user account. In one or more embodiments, based on a user interaction with the global selection option, the collaborative document locking system 102 can modify the editing permissions associated with the user account accessing the collaborative content item for a selection (e.g., one or more) of the collaborative content items associated with the user account.

Furthermore, the collaborative document locking system 102 can lock/unlock editing permissions based on an associated user account. Indeed, in one or more embodiments, based on a first user account interaction with the associated account selection option (e.g., user-specific lock indication), the collaborative document locking system 102 can modify the editing permissions associated with the first user account accessing the collaborative content item for collaborative content items associated with another user account. For example, the collaborative document locking system 102 can lock/unlock the editing permissions associated with the first user account for collaborative content items that another user account has: edited in the past, been provided access to, is the creator of, has edited/viewed/created within a threshold period of time, is the owner of, has accessed, and/or has duplicated.

Notably, the collaborative document locking system 102 can lock/unlock the editing permissions associated with a first user account for collaborative content items based on a combination of different associations with the collaborative content item from multiple additional user accounts. For example, the collaborative document locking system 102 can disable editing permissions for a first user account for a collaborative content item based on a second user account creating the collaborative content item and a third user account editing the collaborative content item. As another example, the collaborative document locking system 102 can disable editing permissions for a first user account for a collaborative content item based on a second user account accessing the collaborative content item within a threshold time period and a third user account viewing the collaborative content item within a threshold time period. Indeed, the collaborative document locking system 102 can lock/unlock the editing permissions associated with the user account for collaborative content items based on an unlimited combination of associations with the collaborative content item by multiple additional user accounts.

Relatedly, in one or more embodiments, based on a user account interaction with the associated group selection option (e.g., group-specific lock indication), the collaborative document locking system 102 can modify the editing permissions associated with the user account accessing the collaborative content item for collaborative content items associated with a group of user accounts. For example, the collaborative document locking system 102 can lock/unlock the editing permissions associated with a first user account for collaborative content items that a group of user accounts: has been provided access to, has ownership permissions for, has edited within a threshold period of time, has accessed, and/or has duplicated.

Additionally, the collaborative document locking system 102 can lock/unlock editing permissions based on a date. Indeed, in one or more embodiments, based on a user account interaction with the date selection option (e.g., date-based lock indication), the collaborative document locking system 102 can modify the editing permissions associated with the user account accessing the collaborative content item for collaborative content items associated with a date and/or range of dates. For example, the collaborative document locking system 102 can lock/unlock the editing permissions associated with the user account for collaborative content items that have been accessed, were created, and/or have been edited within a date range.

Moreover, the collaborative document locking system 102 can lock/unlock editing permissions based on a selection. Indeed, in one or more embodiments, based on a user account interaction with the selection option (e.g., selection-based lock indication), the collaborative document locking system 102 can modify the editing permissions associated with the user account accessing the collaborative content item for selected content within the collaborative content item (e.g., content within the collaborative content item selected by the user account). For example, the collaborative document locking system 102 can lock/unlock the editing permissions associated with the user account for a portion of the collaborative content item while maintaining the editing permissions associated with the user account (as well as the other user accounts) for the remainder of the collaborative content item.

As mentioned, the collaborative document locking system 102 can lock/unlock a collaborative content item based on the lock duration. In particular, the collaborative document locking system 102 can lock the collaborative content item based on a current session, until the lock is disabled, for a set time, and/or upon opening the collaborative content item.

For example, the collaborative document locking system 102 can lock/unlock editing permissions based on a current viewing session. Indeed, in one or more embodiments, based on a user account interaction with the session selection option (e.g., session-based lock indication), the collaborative document locking system 102 can modify the editing permissions associated with the user account accessing the collaborative content item for the current viewing session of the collaborative content item. Indeed, when the sessions selection option is selected, the collaborative document locking system 102 can re-enable the editing permissions associated with the user account accessing the collaborative content item for subsequent viewing sessions of the collaborative content item without further user interaction.

Furthermore, the collaborative document locking system 102 can lock/unlock editing permissions until the collaborative document locking system 102 receives an indication to restore the lock/unlock editing permissions. Indeed, in one or more embodiments, based on a user account interaction with the persist selection option (e.g., persist-based lock indication), the collaborative document locking system 102 can modify the editing permissions associated with the user account accessing the collaborative content item for the current viewing session of the collaborative content item and subsequent viewing sessions of the collaborative content item. Indeed, when the persist selection option is selected, the collaborative document locking system 102 can disable the editing permissions associated with the user account accessing the collaborative content item for subsequent viewing sessions until collaborative document locking system 102 receives an indication to restore the lock/unlock editing permissions.

Additionally, the collaborative document locking system 102 can lock/unlock editing permissions for a specific amount of time. Indeed, in one or more embodiments, based on a user account interaction with the timed selection option (e.g., time-based lock indication), the collaborative document locking system 102 can modify the editing permissions associated with the user account accessing the collaborative content item for the collaborative content item for a specific amount of time. Indeed, when the timed selection option is selected, the collaborative document locking system 102 can disable the editing permissions associated with the user account accessing the collaborative content item for a set length of time and/or a user specified time/date range (e.g., a subsequent time period).

Relatedly, the collaborative document locking system 102 can lock/unlock editing permissions when accessing a collaborative content item. Indeed, in one or more embodiments, based on a user account interaction with the upon opening selection option (e.g., access-based lock indication), the collaborative document locking system 102 can modify the editing permissions associated with the user account accessing the collaborative content item for the collaborative content item when the collaborative content item is accessed. Indeed, when the upon opening selection option is selected, the collaborative document locking system 102 can disable the editing permissions associated with the user account accessing the collaborative content item for a set length of time when the collaborative content item is opened or disable the editing permissions associated with the user account accessing the collaborative content item until the collaborative document locking system 102 receives an indication to enable the editing permissions. Similarly, in one or more implementations, when the upon-opening selection option is selected, the collaborative document locking system 102 can disable the editing permissions associated with the user account when accessing all collaborative content item (e.g., to provide additional security measures upon opening).

As mentioned, the collaborative document locking system 102 can lock/unlock a collaborative content item based on a feature lock. In particular, based on a user account interaction with one or more feature lock selection options (e.g., one or more partial-lock indications), the collaborative document locking system 102 can lock the collaborative content item associated with specific features such as commenting, adding content, deleting content, formatting content, executing content, or highlighting content.

For example, the collaborative document locking system 102 can lock/unlock editing permissions associated with adding comments to the collaborative content item. Indeed, in one or more embodiments, based on a user account interaction with the comments selection option (e.g., comment-based lock indication), the collaborative document locking system 102 can modify the comment editing permissions associated with the user account accessing the collaborative content item for the collaborative content item. For example, when the comments selection option is selected, the collaborative document locking system 102 can disable the editing permissions associated with the user account and restrict the user account's ability to add, remove, or modify comments within the collaborative content item.

Further, the collaborative document locking system 102 can lock/unlock editing permissions associated with adding or deleting content of the collaborative content item. Indeed, in one or more embodiments, based on a user account interaction with the add selection option (e.g., add-based lock indication), the collaborative document locking system 102 can modify the adding content editing permissions associated with the user account accessing the collaborative content item for the collaborative content item. For example, when the add selection option is selected, the collaborative document locking system 102 can disable the adding content editing permissions associated with the user account and restrict the user account's ability to add content within the collaborative content item. Similarly, in one or more embodiments, based on a user account interaction with the delete selection option (e.g., delete-based lock indication), the collaborative document locking system 102 can modify the deleting content editing permissions associated with the user account accessing the collaborative content item for the collaborative content item. For example, when the delete selection option is selected, the collaborative document locking system 102 can disable the deleting content editing permissions associated with the user account and restrict the user account's ability to delete content within the collaborative content item.

Moreover, the collaborative document locking system 102 can lock/unlock editing permissions associated with formatting or highlighting content of the collaborative content item. Indeed, in one or more embodiments, based on a user account interaction with the format selection option (e.g., format-based lock indication), the collaborative document locking system 102 can modify the format content editing permissions associated with the user account accessing the collaborative content item for the collaborative content item. For example, when the format selection option is selected, the collaborative document locking system 102 can disable the formatting content editing permissions associated with the user account and restrict the user account's ability to format content to maintain consistent formatting within the collaborative content item. Similarly, in one or more embodiments, based on a user account interaction with the highlight selection option (e.g., highlight-based lock indication), the collaborative document locking system 102 can modify the highlight content editing permissions associated with the user account accessing the collaborative content item for the collaborative content item. For example, when the highlight selection option is selected, the collaborative document locking system 102 can disable the highlight content editing permissions associated with the user account and restrict the user account's ability to highlight (e.g., emphasize) content within the collaborative content item.

Additionally, the collaborative document locking system 102 can lock/unlock editing permissions associated with executing content of the collaborative content item. Indeed, in one or more embodiments, based on a user account interaction with the execute selection option (e.g., execute-based lock indication), the collaborative document locking system 102 can modify the execute editing permissions associated with the user account accessing the collaborative content item for the collaborative content item. For example, when the execute selection option is selected, the collaborative document locking system 102 can disable the execute content editing permissions associated with the user account and restrict the user account's ability to execute a file or program (e.g., as an additional security measure).

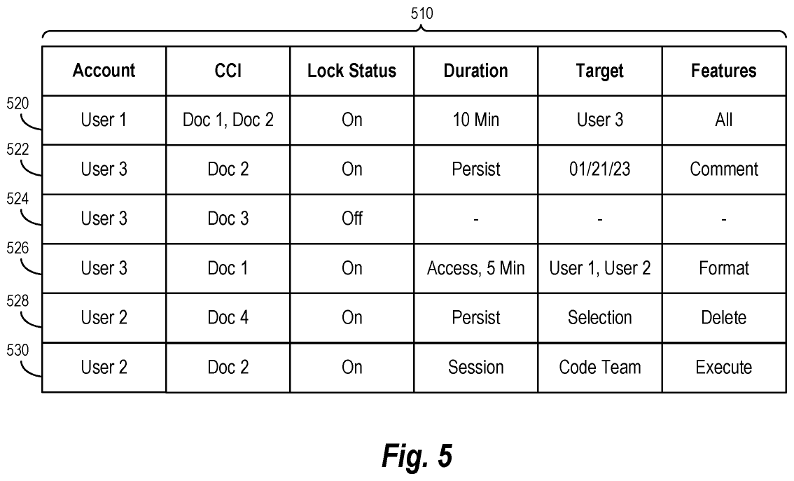

As mentioned above, the collaborative document locking system 102 can utilize a permission data table to organize and manage permissions for user accounts. FIG. 5 illustrates an example collaborative document locking system 102 permission data table which includes lock/unlock permissions assigned to user accounts for various collaborative content items.

As shown on FIG. 5, the collaborative document locking system 102 can utilize a permission data table to store data 510 and associate a user account with a collaborative content item (CCI), lock status, duration, target, and features. For example, as shown in row 520, the collaborative document locking system 102 can utilize the permission data table to disable the editing permissions (e.g., lock status “On”) associated with a user account (e.g., Account “User1”) for all features (e.g., Features “All”) for two collaborative content items (e.g., CCI “Doc1, Doc2”) associated with a lock target (Target “User3”) for a 10-minute duration (e.g., Duration “10 min”). Similarly, as mentioned but not shown, the collaborative document locking system 102 can lock the editing features for a specific time range such as Jan. 8, 2023-Jan. 10, 2023 (e.g., Duration “Jan. 8, 2023-Jan. 10, 2023”).

As also shown in row 522, the collaborative document locking system 102 can utilize the permission data table to disable the editing permissions (e.g., lock status “On”) associated with a user account (e.g., Account “User3”) for editing comments (e.g., Features “Comment”) for a collaborative content item (e.g., CCI “Doc2”) associated with a specific date (Target “Jan. 21, 2023”) until the editing permissions are re-enabled (e.g., Duration “persist”). Similarly, as mentioned and not shown, the collaborative document locking system 102 can lock the editing features for files associated with a specific date range such as Jan. 21, 2023-Jan. 29, 2023 (e.g., Target “Jan. 21, 2023-Jan. 29, 2023”).

As also shown in row 524, the collaborative document locking system 102 can utilize the permission data table to enable the editing permissions (e.g., lock status “Off”) associated with a user account (e.g., Account “User3”) for a collaborative content item (e.g., CCI “Doc3”).

As also shown in row 526, the collaborative document locking system 102 can utilize the permission data table to disable the editing permissions (e.g., lock status “On”) associated with a user account (e.g., Account “User3”) for formatting editing features (e.g., Features “Format”) for a collaborative content item (e.g., CCI″Doc1″) associated with specific target accounts (Target “User1, User2”) for a 5-minute duration upon opening the collaborative content item for the current viewing session (e.g., Duration “Access, 5 min”). Notably, as shown by the permission data table, User1 and User2 have selected different editing permissions and the collaborative document locking system 102 has enabled these different editing permissions for Doc1. In particular, as shown in row 520, User1 has selected to be disabled from editing Doc1 (e.g., all documents associated with User3) for a 10-minute duration. In contrast, as shown in row 526, User3 has selected the option to disable formatting changes to Doc1 (as long as Doc1 is associated with User1 or User2), for a 5-minute duration upon opening Doc1. Note, in the demonstrative example shown in FIG. 5, Doc1 is associated with User1 and User 3, but not User2.

Further, as shown in row 528, the collaborative document locking system 102 can utilize the permission data table to disable the editing permissions (e.g., lock status “On”) associated with a user account (e.g., Account “User2”) for deleting collaborative content item content (e.g., Features “Delete”) for a collaborative content item (e.g., CCI “Doc4”) associated with selected content within the collaborative content item (Target “Selection”) until re-enabled (e.g., Duration “Persist”).

Further, as shown in row 530, the collaborative document locking system 102 can utilize the permission data table to disable the editing permissions (e.g., lock status “On”) associated with a user account (e.g., Account “User2”) for execute editing features (e.g., Features “Execute”) for a collaborative content item (e.g., CCI “Doc2”) associated with an associated user group (Target “Code Team”) for the current viewing session (e.g., Duration “Session”). Notably, as shown by the permission data table, User2 and User3 have selected different editing permissions and the collaborative document locking system 102 has enabled these different editing permissions for Doc2. In particular, as shown in row 522, User3 has selected to disable commenting in Doc2 until a further selection to have the editing permissions enabled (e.g., Duration “Persist”). In contrast, as shown in row 530, User2 has selected to disable executing of Doc1, as long as Doc1 is associated with the Code Team, for the current viewing session.

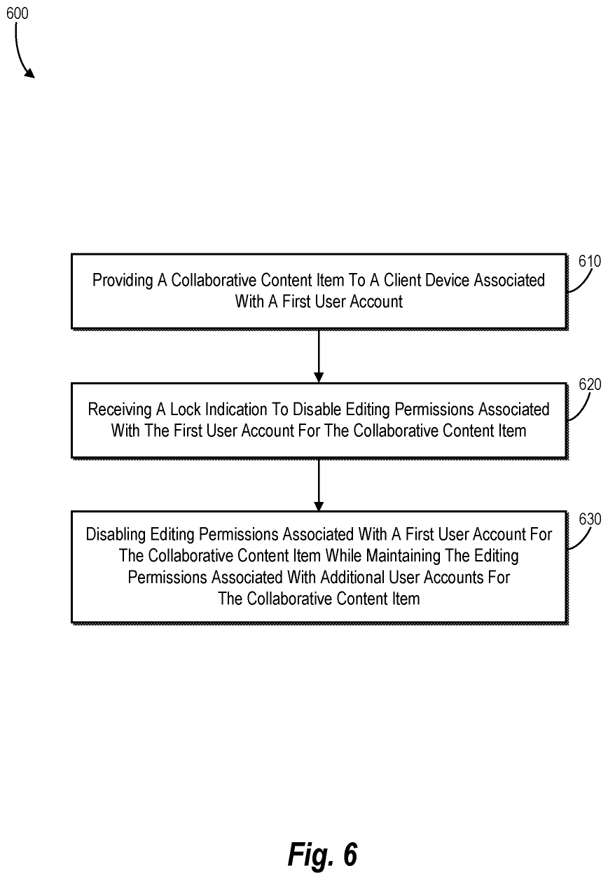

FIGS. 1-5, the corresponding text, and the examples provide a number of different systems and methods for generating and providing synthesized tasks using digital content from third-party data sources. In addition to the foregoing, implementations can also be described in terms of flowcharts comprising acts/steps in a method for accomplishing a particular result. For example, FIG. 6 illustrates an example series of acts for generating and providing a synthesized task from multiple third-party applications.

As illustrated in FIG. 6, the series of acts 600 may include an act 610 of providing a collaborative content item to a client device associated with a user account. For example, in one or more embodiments, the act 610 can include providing, by a content management system to a first client device associated with a first user account, a collaborative content item, the collaborative content item being accessible by the first user account and additional user accounts associated with additional client devices.

In addition, the series of acts 600 includes an act 620 of receiving a lock indication to disable editing permissions associated with the first account for the collaborative content item. In one or more embodiments, the act 620 can include receiving, by the content management system from the first client device, a lock indication to disable editing permissions associated with the first user account for the collaborative content item.

As further illustrated in FIG. 6, the series of acts 600 includes an act 630 of disabling editing permissions associated with a first account for the collaborative content item while maintaining the editing permissions associated with additional user accounts for the collaborative content item. In one or more embodiments, as described above, the act 630 can involve disabling editing permissions associated with the first user account for a plurality of collaborative content items associated with the first user account while maintaining editing permissions associated with the additional user accounts for the plurality of collaborative content items.

Further, in one or more embodiments, the series of acts 600 includes maintaining the locked status for the collaborative content item until receiving an unlock indication from the first client device. In addition, in one or more embodiments, the series of acts 600 includes maintaining the locked status for the editing permissions of the collaborative content item until an end of a viewing session associated with the first client device.

Additionally, in one or more embodiments, the series of acts 600 includes receiving, by the content management system from the first client device, a global lock indication to disable global editing permissions associated with the first user account for a plurality of collaborative content items associated with the first user account; and disabling editing permissions associated with the first user account for a plurality of collaborative content items associated with the first user account while maintaining editing permissions associated with the additional user accounts for the plurality of collaborative content items. Additionally, in one or more embodiments, the series of acts 600 includes disabling editing permissions for the collaborative content item for the first user account by updating editing permissions in a permission data table associated with the collaborative content item.

Moreover, in one or more embodiments, the series of acts 600 includes receiving, by the content management system from the first client device, a user-specific lock indication to disable editing permissions associated with the first user account for a plurality of collaborative content items associated with a second user account; and disabling editing permissions associated with the first user account for a plurality of collaborative content items associated with the second user account. Further, in one or more embodiments, the series of acts 600 includes receiving, by the content management system from the first client device, a partial-lock indication to enable at least one editing feature associated with the first user account for the collaborative content item; and based on receiving the partial-lock indication, enabling the at least one editing feature associated with the first user account for the collaborative content item to create a partial-locked status while disabling one or more other editing features associated with the first user account for the collaborative content item.

Furthermore, in one or more embodiments, the series of acts 600 includes providing, by a content management system to a second client device associated with a second user account, the collaborative content item; receiving, by the content management system from the second client device, an edit request to edit content of the collaborative content item; and modifying, by the content management system, the collaborative content item based on the edit request from the second client device while maintaining the locked status associated with the first user account for the collaborative content item.

Further, in one or more embodiments, the series of acts 600 includes receiving, by the content management system from the second client device, a second lock indication to disable editing permissions associated with the second user account for the collaborative content item; disabling editing permissions associated with the second user account for the collaborative content item to create a second locked status while maintaining the editing permissions associated with the additional user accounts for the collaborative content item; receiving, by the content management system from the first client device, an unlock indication to enable editing permissions associated with the first user account for the collaborative content item; and enabling editing permissions associated with the first user account for the collaborative content item to create an unlocked status while maintaining the editing permissions associated with the additional user accounts for the collaborative content item.

Additionally, in one or more embodiments, the series of acts 600 causes the system to provide a collaborative content item, the collaborative content item being accessible by a first user account associated with a first client device and additional user accounts associated with additional client devices; receive a lock indication to disable editing permissions associated with the first user account for the collaborative content item; disable editing permissions associated with the first user account for the collaborative content item to create a locked status while maintaining the editing permissions associated with the additional user accounts for the collaborative content item; and provide a visible indication that the collaborative content item is in the locked status or is in an unlocked status. Moreover, in one or more embodiments, the series of acts 600 causes the system to provide, for display on the first client device, a selectable option with the collaborative content item to toggle between enabling or disabling editing permissions associated with the first user account for the collaborative content item while maintaining the editing permissions for the additional user accounts.

Furthermore, in one or more embodiments, the series of acts 600 includes providing, by a content management system to a first client device associated with a first user account, a collaborative content item, the collaborative content item being accessible by the first user account and additional user accounts associated with additional client devices; receiving, by the content management system from the first client device, a lock indication to disable editing permissions associated with the first user account for the collaborative content item; disabling editing permissions associated with the first user account for the collaborative content item to create a locked status while maintaining the editing permissions associated with the additional user accounts for the collaborative content item; and providing a visible indication that the collaborative content item is in the locked status or is in an unlocked status. Moreover, in one or more embodiments, the series of acts 600 includes creating a locked status that is a time-based locked status, that disables editing to the collaborative content item for a specified period of time. In addition, in one or more embodiments, the series of acts 600 includes causing the computing device to provide, by the content management system to the first client device, a notification of the locked status or an unlocked status of the collaborative content item upon accessing the collaborative content item.

Furthermore, in one or more embodiments, the series of acts 600 includes causing the computing device to receive, by the content management system from the first client device, a group-specific lock indication to disable editing permissions associated with the first user account for a plurality of collaborative content items associated with a designated group of user accounts; and disabling editing permissions associated with the first user account for a plurality of collaborative content items associated with the designated group of user accounts.

In one or more implementations, each of the components of the collaborative document locking system 102 are in communication with one another using any suitable communication technologies. Additionally, the components of the collaborative document locking system 102 can be in communication with one or more other devices including one or more client devices described above. It will be recognized that in as much the collaborative document locking system 102 is shown to be separate in the above description, any of the subcomponents may be combined into fewer components, such as into a single component, or divided into more components as may serve a particular implementation.

The components of the collaborative document locking system 102 can include software, hardware, or both. For example, the components of the collaborative document locking system 102 can include one or more instructions stored on a computer-readable storage medium and executable by processors of one or more computing devices (e.g., the computing device 700). When executed by the one or more processors, the computer-executable instructions of the collaborative document locking system 102 can cause the computing device 700 to perform the methods described herein. Alternatively, the components of the collaborative document locking system 102 can comprise hardware, such as a special purpose processing device to perform a certain function or group of functions. Additionally, or alternatively, the components of the collaborative document locking system 102 can include a combination of computer-executable instructions and hardware.

Furthermore, the components of the collaborative document locking system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the collaborative document locking system 102 may be implemented as part of a stand-alone application on a personal computing device or a mobile device.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of exemplary computing device 700 that may be configured to perform one or more of the processes described above. One will appreciate that server(s) 104, the client device(s) 108a-108n, and/or the computing device 700 may comprise one or more computing devices such as computing device 700. As shown by FIG. 7, computing device 700 can comprise processor 702, memory 704, a storage device, a I/O interface, and communication interface 710, which may be communicatively coupled by way of communication infrastructure 712. While an exemplary computing device 700 is shown in FIG. 7, the components illustrated in FIG. 7 are not intended to be limiting. Additional or alternative components may be used in other implementations. Furthermore, in certain implementations, computing device 700 can include fewer components than those shown in FIG. 7. Components of computing device 700 shown in FIG. 7 will now be described in additional detail.

In particular implementations, processor 702 includes hardware for executing instructions, such as those making up a computer program. As an example and not by way of limitation, to execute instructions, processor 702 may retrieve (or fetch) the instructions from an internal register, an internal cache, memory 704, or storage device 706 and decode and execute them. In particular implementations, processor 702 may include one or more internal caches for data, instructions, or addresses. As an example and not by way of limitation, processor 702 may include one or more instruction caches, one or more data caches, and one or more translation lookaside buffers (TLBs). Instructions in the instruction caches may be copies of instructions in memory 704 or storage device 706.

Memory 704 may be used for storing data, metadata, and programs for execution by the processor(s). Memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 704 may be internal or distributed memory.

Storage device 706 includes storage for storing data or instructions. As an example and not by way of limitation, storage device 706 can comprise a non-transitory storage medium described above. Storage device 706 may include a hard disk drive (HDD), a floppy disk drive, flash memory, an optical disc, a magneto-optical disc, magnetic tape, or a Universal Serial Bus (USB) drive or a combination of two or more of these. Storage device 706 may include removable or non-removable (or fixed) media, where appropriate. Storage device 706 may be internal or external to computing device 700. In particular implementations, storage device 706 is non-volatile, solid-state memory. In other implementations, Storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 708 allows a user to provide input to, receive output from, and otherwise transfer data to and receive data from computing device 700. I/O interface 708 may include a mouse, a keypad or a keyboard, a touch screen, a camera, an optical scanner, network interface, modem, other known I/O devices or a combination of such I/O interfaces. I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 708 is configured to provide graphical data to a display for presentation to a user. The graphical data may be representative of one or more graphical user interfaces and/or any other graphical content as may serve a particular implementation.

Communication interface 710 can include hardware, software, or both. In any event, communication interface 710 can provide one or more interfaces for communication (such as, for example, packet-based communication) between computing device 700 and one or more other computing devices or networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 710 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 710 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 712 may include hardware, software, or both that couples components of computing device 700 to each other. As an example and not by way of limitation, communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 8 is a schematic diagram illustrating environment 800 within which one or more implementations of the collaborative document locking system 102 can be implemented. As discussed above with respect to FIG. 1, in some embodiments the collaborative document locking system can be part of a content management system. In such cases, the collaborative document locking system can perform various functions a content management system performs, as described below. The content management system 802 may generate, store, manage, receive, and send digital content (such as digital videos). For example, content management system 802 may send and receive digital content to and from client devices 806 by way of network 804. In particular, the content management system 802 can store and manage a collection of digital content. The content management system 802 can manage the sharing of digital content between computing devices associated with a plurality of users. For instance, the content management system 802 can facilitate a user sharing a digital content with another user of content management system 802.

In particular, the content management system 802 can manage synchronizing digital content across multiple client devices 806 associated with one or more users. For example, a user may edit digital content using client device 806. The content management system 802 can cause client device 806 to send the edited digital content to content management system 802. Content management system 802 then synchronizes the edited digital content on one or more additional computing devices.

In addition to synchronizing digital content across multiple devices, one or more implementations of content management system 802 can provide an efficient storage option for users that have large collections of digital content. For example, content management system 802 can store a collection of digital content on content management system 802, while the client device 806 only stores reduced-sized versions of the digital content. A user can navigate and browse the reduced-sized versions (e.g., a thumbnail of a digital image) of the digital content on client device 806. In particular, one way in which a user can experience digital content is to browse the reduced-sized versions of the digital content on client device 806.

Another way in which a user can experience digital content is to select a reduced-size version of digital content to request the full- or high-resolution version of digital content from content management system 802. In particular, upon a user selecting a reduced-sized version of digital content, client device 806 sends a request to content management system 802 requesting the digital content associated with the reduced-sized version of the digital content. Content management system 802 can respond to the request by sending the digital content to client device 806. Client device 806, upon receiving the digital content, can then present the digital content to the user. In this way, a user can have access to large collections of digital content while minimizing the amount of resources used on client device 806.

Client device 806 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 806 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 804.

Network 804 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 806 may access content management system 802.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
providing, by a content management system to a first client device associated with a first user account, a collaborative content item, the collaborative content item being accessible by the first user account and additional user accounts associated with additional client devices;
receiving, by the content management system from the first client device, a lock indication to disable editing permissions associated with the first user account for the collaborative content item; and
disabling editing permissions associated with the first user account for the collaborative content item to create a locked status while maintaining the editing permissions associated with the additional user accounts for the collaborative content item.

2. The computer-implemented method of claim 1, further comprising maintaining the locked status for the collaborative content item until receiving an unlock indication from the first client device.

3. The computer-implemented method of claim 1, further comprising maintaining the locked status for the editing permissions of the collaborative content item until an end of a viewing session associated with the first client device.

4. The computer-implemented method of claim 1, further comprising:
receiving, by the content management system from the first client device, a global lock indication to disable global editing permissions associated with the first user account for a plurality of collaborative content items associated with the first user account; and
disabling editing permissions associated with the first user account for a plurality of collaborative content items associated with the first user account while maintaining editing permissions associated with the additional user accounts for the plurality of collaborative content items.

5. The computer-implemented method of claim 1, further comprising disabling editing permissions for the collaborative content item for the first user account by updating editing permissions in a permission data table associated with the collaborative content item.

6. The computer-implemented method of claim 1, further comprising:
receiving, by the content management system from the first client device, a user-specific lock indication to disable editing permissions associated with the first user account for a plurality of collaborative content items associated with a second user account; and
disabling editing permissions associated with the first user account for a plurality of collaborative content items associated with the second user account.

7. The computer-implemented method of claim 1, further comprising:
receiving, by the content management system from the first client device, a partial-lock indication to enable at least one editing feature associated with the first user account for the collaborative content item; and
based on receiving the partial-lock indication, enabling the at least one editing feature associated with the first user account for the collaborative content item to create a partial-locked status while disabling one or more other editing features associated with the first user account for the collaborative content item.

8. The computer-implemented method of claim 1, further comprising:
providing, by a content management system to a second client device associated with a second user account, the collaborative content item;
receiving, by the content management system from the second client device, an edit request to edit content of the collaborative content item; and
modifying, by the content management system, the collaborative content item based on the edit request from the second client device while maintaining the locked status associated with the first user account for the collaborative content item.

9. The computer-implemented method of claim 8, further comprising:
receiving, by the content management system from the second client device, a second lock indication to disable editing permissions associated with the second user account for the collaborative content item;
disabling editing permissions associated with the second user account for the collaborative content item to create a second locked status while maintaining the editing permissions associated with the additional user accounts for the collaborative content item;
receiving, by the content management system from the first client device, an unlock indication to enable editing permissions associated with the first user account for the collaborative content item; and
enabling editing permissions associated with the first user account for the collaborative content item to create an unlocked status while maintaining the editing permissions associated with the additional user accounts for the collaborative content item.

10. A system comprising:
at least one processor; and
a non-transitory computer readable medium comprising instructions that, when executed by the at least one processor, cause the system to:
provide a collaborative content item, the collaborative content item being accessible by a first user account associated with a first client device and additional user accounts associated with additional client devices;
receive a lock indication to disable editing permissions associated with the first user account for the collaborative content item;
disable editing permissions associated with the first user account for the collaborative content item to create a locked status while maintaining the editing permissions associated with the additional user accounts for the collaborative content item; and
provide a visible indication that the collaborative content item is in the locked status or is in an unlocked status.

11. The system of claim 10, further comprising instructions that, when executed by the at least one processor, cause the system to maintain the locked status for the editing permissions of the collaborative content item until an end of a viewing session associated with the first client device.

12. The system of claim 10, further comprising instructions that, when executed by the at least one processor, cause the system to disable editing permissions for the collaborative content item for the first user account by updating editing permissions in a permission data table associated with the collaborative content item.

13. The system of claim 10, further comprising instructions that, when executed by the at least one processor, cause the system to provide, for display on the first client device, a selectable option with the collaborative content item to toggle between enabling or disabling editing permissions associated with the first user account for the collaborative content item while maintaining the editing permissions for the additional user accounts.

14. The system of claim 10, further comprising instructions that, when executed by the at least one processor, cause the system to:
provide, to a second client device associated with a second user account, the collaborative content item;
receive, from the second client device, an edit request to edit content of the collaborative content item; and
modify, the collaborative content item based on the edit request from the second client device while maintaining the locked status associated with the first user account for the collaborative content item.

15. The system of claim 14, further comprising instructions that, when executed by the at least one processor, cause the system to:
receive, from the second client device, a second lock indication to disable editing permissions associated with the second user account for the collaborative content item;
disable editing permissions associated with the second user account for the collaborative content item to create a second locked status while maintaining the editing permissions associated with the additional user accounts for the collaborative content item;
receive, an unlock indication to enable editing permissions associated with the first user account for the collaborative content item; and
enable editing permissions associated with the first user account for the collaborative content item to create an unlocked status while maintaining the editing permissions associated with the additional user accounts for the collaborative content item.

16. A non-transitory computer readable medium comprising instructions that, when executed by at least one processor, cause a computing device to:
provide, by a content management system to a first client device associated with a first user account, a collaborative content item, the collaborative content item being accessible by the first user account and additional user accounts associated with additional client devices;
receive, by the content management system from the first client device, a lock indication to disable editing permissions associated with the first user account for the collaborative content item;
disable editing permissions associated with the first user account for the collaborative content item to create a locked status while maintaining the editing permissions associated with the additional user accounts for the collaborative content item; and
provide a visible indication that the collaborative content item is in the locked status or is in an unlocked status.

17. The non-transitory computer readable medium of claim 16, wherein the locked status is a time-based locked status, that disables editing to the collaborative content item for a specified period of time.

18. The non-transitory computer readable medium of claim 16, further comprising instructions that, when executed by the at least one processor, cause the computing device to:
provide, by a content management system to a second client device associated with a second user account, the collaborative content item;
receive, by the content management system from the second client device, an edit request to edit content of the collaborative content item; and
modify, by the content management system, the collaborative content item based on the edit request from the second client device while maintaining the locked status associated with the first user account for the collaborative content item.

19. The non-transitory computer readable medium of claim 16, further comprising instructions that, when executed by the at least one processor, cause the computing device to provide, by the content management system to the first client device, a notification of the locked status or an unlocked status of the collaborative content item upon accessing the collaborative content item.

20. The non-transitory computer readable medium of claim 16, further comprising instructions that, when executed by the at least one processor, cause the computing device to:
receive, by the content management system from the first client device, a group-specific lock indication to disable editing permissions associated with the first user account for a plurality of collaborative content items associated with a designated group of user accounts; and
disable editing permissions associated with the first user account for a plurality of collaborative content items associated with the designated group of user accounts.
